(19) United States
(12) Patent Application Publication
(10) Pub. No.: US 2011/0153079 A1
(43) Pub. Date: Jun. 23, 2011

(54) APPARATUS AND METHOD FOR DISTRIBUTING AND MONITORING ROBOT APPLICATION AND ROBOT DRIVEN THEREBY

(75) Inventors: Seung-Woog JUNG, Daejeon (KR); Choul-Soo Jang, Daejeon (KR); Byoung-Youl Song, Daejeon (KR)

(73) Assignee: ELECTRONICS AND TELECOMMUNICATION RESEARCH INSTITUTE, Daejeon (KR)

(21) Appl. No.: 12/971,113

(22) Filed: Dec. 17, 2010

(30) Foreign Application Priority Data
Dec. 18, 2009 (KR) 2009-0126723
Mar. 29, 2010 (KR) 2010-0027998

(51) Int. Cl. G05B 19/418; G06F 19/00

(52) U.S. Cl. 700/248; 700/245

(57) ABSTRACT

Provided is a technology that effectively distributes and monitors the execution of robot application to allow a plurality of robots to perform tasks in cooperation with each other. An apparatus for distributing and monitoring robot application according to an embodiment of the present invention comprises: a robot information manager managing information of a plurality of robots constituted by a plurality of nodes classified by a driving function; a robot application generator generating the robot application combining a plurality of components for driving the plurality of robots; and a robot application controller distributing the robot application to the plurality of robots on the basis of the information of the plurality of robots and receiving execution monitoring information of the robot application.

### CROSS REFERENCE TO RELATED APPLICATION

This application claims the benefit of Korean Patent Application No. 10-2009-0126723, filed on Dec. 18, 2009 and Korean Patent Application No. 10-2010-0027998, filed on Mar. 29, 2010, which are hereby incorporated by reference in its entirety into this application.

### BACKGROUND OF THE INVENTION

1. Field of the Invention

The present invention relates to a technology in which a plurality of robots performs a predetermined task in cooperation with each other. More particularly, the present invention relates to a technology that distributes robot application required to perform the task to a plurality of robots, and controls allocation and execution of a plurality of components included in the distributed robot application.

2. Description of the Related Art

Research about technologies related to robots has rapidly increased. In recent years, research about a technology that performs a predetermined function by using a driving characteristic of a robot as well as a technology related to the driving of the robot itself.

In particular, a technology related to robot application in which a plurality of robots performs a predetermined task in cooperation with each other by using their own functions has developed.

Basically, each of the plurality of robots, that is, one robot comprises a plurality of nodes. The node represents a basic unit that takes charge of the driving of the robots. For example, a node that takes charge of the operation of a robot sensor and a node that takes charge of the physical driving of the robot may be included in one robot. Further, nodes having a plurality of functions included in robot, respectively may be installed in other robots.

In this case, a technology of integratively distributing the robot application to a plurality of robots constituted by a plurality of nodes is required. Further, when the robot application is distributed to a plurality of robots, there is a priority in executing components (a basic unit of a program included in the robot application) included in the robot application among the nodes included in each robot.

In this case, after the robot application is distributed to each node, a technology for systematically executing the robot application in accordance with a predetermined execution sequence is required. Further, in the case in which only some components in the robot application are executed and the rest of the components are not executed due to errors, the robot application may not normally be executed. Therefore, a technology for cope with the problem is also required.

### SUMMARY OF THE INVENTION

The present invention has been made in an effort to distribute robot application to a plurality of robots and systematically execute the robot application under a robot application environment constituted by a robot including a plurality of nodes and a plurality of components. Further, the present invention has been another effort to effectively manage the normal execution of the robot application by systematically managing the robot application distributed and executed to a plurality of robots.

An embodiment of the present invention provides an apparatus for distributing and monitoring robot application that comprises: a robot information manager managing information of a plurality of robots constituted by a plurality of nodes classified by a function; a robot application generator generating the robot application combining a plurality of components for driving the plurality of robots; and a robot application controller distributing the robot application to the plurality of robots on the basis of the information of the plurality of robots and receiving execution monitoring information of the robot application.

The robot application controller may further have a function of generating a command to execute each of the plurality of components in accordance with a predetermined execution sequence. Further, the robot application controller may further have a function of generating a command to stop the execution of the robot application when it is determined that any one of the plurality of components violates the predetermined execution sequence.

The plurality of components may exist in an external server and the robot application generator may retrieve and receive the plurality of components from the external server.

The information of the plurality of robots may include at least one of identification information of the robots, functional information of the robots, functional information of the plurality of nodes, and IP address information and IP port numbers information of the plurality of nodes.

Further, the robot application controller may distribute the robot application including the plurality of components which are corresponding to each of the plurality of nodes and included in the plurality of robots, on the basis of the information of the plurality of robots at the time of distributing the robot application.

The robot application controller may generate the command to stop the execution of the entire robot application because the execution of the entire robot application may have the error when an error occurs in the execution of any one of the plurality of components included in the robot application on the basis of the execution monitoring information.

Another embodiment of the present invention provides a robot driven by robot application that comprises: a plurality of execution nodes; a command receiver receiving at least one of a plurality of components included in the robot application and an execution control command from a robot application management device; a component allocator allocating at least one of the plurality of components and the execution control command to a plurality of execution nodes based on information of the robot; and an execution monitoring unit monitoring whether or not the components corresponding to the plurality of execution nodes are normally executed.

Still another embodiment of the present invention provides a method for distributing and monitoring robot application that comprises: managing information of a plurality of robots constituted by a plurality of nodes classified by a driving function by a robot information manager; generating the robot application by combining a plurality of components for driving the plurality of robots by a robot application generator; distributing the robot application to the plurality of robots on the basis of the information of the plurality of robots by a robot application controller; and receiving execution monitoring information of the robot application by the robot application controller.

According to the embodiments of the present invention, under a robot application environment where a plurality of robots perform predetermined tasks in cooperation with each other, it is possible to effectively distribute robot application to a plurality of components included in a plurality of robots. Further, it is possible to execute the robot application in accordance with an execution sequence in each node by allocating the plurality of components and an execution command to a plurality of nodes, respectively. When an error occurs in the execution sequence of the plurality of components included in the robot application or the execution of each of the plurality of components, it is possible to effectively cope with the error by using a monitoring unit at the time of executing the component.

### BRIEF DESCRIPTION OF THE DRAWINGS

FIG. 1 is a block diagram of an apparatus for distributing and monitoring robot application according to an embodiment of the present invention;

FIG. 2 is a block diagram of a robot driven by robot application according to an embodiment of the present invention;

FIG. 3 illustrates a function of a component allocator;

FIG. 4 illustrates an example of a use screen of an apparatus for distributing and monitoring robot application in a user terminal;

FIG. 5 illustrates a configuration example of information of robot of the present invention; and

FIG. 6 is a flowchart of a method for distributing and monitoring robot application according to an embodiment of the present invention.

### DETAILED DESCRIPTION OF THE PREFERRED EMBODIMENTS

Hereinafter, an apparatus and a method for distributing and monitoring robot application and a robot driven thereby according to an embodiment of the present invention will be described with reference to the accompanying drawings.

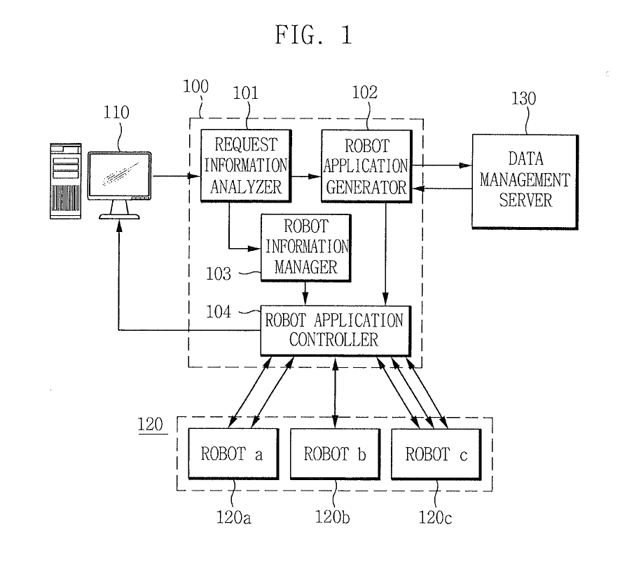

FIG. 1 is a block diagram of an apparatus for distributing and monitoring robot application according to an embodiment of the present invention.

Referring to FIG. 1, the robot application distributing and monitoring apparatus according to the embodiment of the present invention includes a robot information manager 103, a robot application generator 102, and a robot application controller 104. A data management server 130 that stores a plurality of components may additionally be connected to the robot application generator 102. The robot application controller 104 may be connected to a plurality of robots 120. A user terminal 110 may be connected to the robot information manager 103, the robot application generator 102, and the robot application controller 104.

The robot information manager 103 manages information of the plurality of robots 120 constituted by a plurality of nodes classified by a function.

Each of the plurality of robots 120 includes the plurality of nodes classified by the function. Each of the plurality of robots 120 may include other nodes. Accordingly, the plurality of robots 120 may perform different functions. The robot application will represent a program set capable of utilizing functions of the plurality of robots 120.

Each of the plurality of robots 120 may include its unique information. In order to distribute the plurality of components included in the robot application to each of the plurality of robots 120, information of each of the plurality of the robot is required.

In the embodiment of the present invention, the information of each of the plurality of robots 120 may include robot identification information. The robot identification information is information for use in identifying the robot. For example, a serial number of the robot, at least one of an IP address and an IP port number of a representative node among the plurality of nodes included in the robot, or an ID of the robot defined by a user may be included in the robot identification information.

Function information of the robot may also be included in the robot identification information. The function of the robot may represent a predetermined function of the entire robot or a function of the representative node among the plurality of nodes included in the robot. The function of the robot is granted with an identification symbol depending on the function and may be included in the information of the plurality of robots 120.

Information of a function of each of the plurality of nodes may also be included in the information of the robots. The information of the robot may include the functions of the plurality of nodes by classifying the functions of the plurality of nodes included in the robot as the identification information.

An IP address information and an IP port numbers information of each of the plurality of nodes may also be included in the robot information. In order to distribute the plurality of components to the plurality of nodes, an IP address and an IP port numbers of each of the nodes may be stored. Alternately, the IP address and the IP port number may be included in order to identify each of the plurality of nodes included in the robot.

The robot information manager 103 updates and manages the information of the plurality of robots 120 in real time.

Further, the robot information manager 103 may automatically select a robot for executing robot application requested by the user by receiving a user's request from the user terminal 110 or receive a robot selection request from the user. That is, the robot information manager 103 determines robots to which the robot application will be distributed among the plurality of robots 120. Information on the plurality of robots 120 to which the robot application will be distributed will be transferred to the robot application controller 104 from the robot information manager 103.

The robot application generator 102 generates robot application by combining the plurality of components for driving the plurality of robots 120.

While the robot information manager 103 manages the information of the plurality of robots 120, the robot application generator 102 retrieves a program required for the plurality of robots 120 to perform function which user need and generates robot application which is a collection of programs to allow the plurality of robots 120 to perform the plurality of functions in cooperation with each other.

In the embodiment of the present invention, the component represents a basic unit of the program included in the robot application for performing the function of the robot. That is, the component represents a program for a single function of performing a plurality of predetermined functions which the plurality of nodes included in the robot can perform, respectively.

Therefore, the robot application combining a plurality of components which the program for the single function with each other may represent the program collection for performing the plurality of functions. That is, the robot application represents the combination of the components to perform the plurality of functions which the user desires among the functions which the plurality of robots 120 can perform.

The robot application generator 102 combines the components in order to generate the robot application for implementing a user's desired robot function. Therefore, the robot application generator 102 is connected with the user terminal 110 to receive the user's request.

Further, the plurality of components or previously generated robot application may be stored and managed in an external data management server 130. Accordingly, the robot application generator 102 may further include a function of retrieving and receiving the plurality of components from the external data management server 130 (alternately, external server). The robot application generator 102 first receives the user' request and retrieves the components for the function corresponding the user's request at the time of performing the retrieval function and thereafter, may receive the component from the external data management server 130.

The robot application combining the plurality of components with each other may represent not one combined program but a collection in which the plurality of components are combined with each other. When the robot application is distributed to the plurality of robots 120 by the robot application controller 104, the robot application itself will be able to be distributed to robots 120a, 120b, and 120c or the plurality of components required to perform the function of the robot application in the robots 120a, 120b, and 120c, respectively will be able to be distributed.

The robot application generator 120 and the robot information manager 103 may be connected with the user terminal 110. Therefore, the user's request for selecting the robot for the generation of the robot application and the execution of the robot application should be received. Accordingly, the robot application distributing and monitoring apparatus 100 may further include a request information analyzer 101 substituting for analyzing the user's request in the robot application generator 102 and the robot information manager 103.

The request information analyzer 101 analyzes the user's request from the user terminal 110 to extract request information. The request information may include information of the plurality of components which the user desires and information of the plurality of robots 120 which will distribute the robot application for the generating the robot application as described above. Further, the information of the plurality of components may include identification information (i.e., at least one of an IP address and an IP port number of a node) of nodes to which the plurality of components will be distributed.

The request information analyzer 101 may include a function of transferring the extracted request information to each of the robot information manager 103 and the robot application generator 102.

The robot application generator 104 distributes the robot application to the plurality of robots 120 on the basis of the information of the plurality of robots 120 and receives execution monitoring information of the robot application.

The robot application controller 104 may be connected to the plurality of robots 120 in order to receive the execution monitoring information of the robot application. The plurality of robots 120 monitor whether or not the plurality of components normally operate in the plurality of nodes included in each robot and transmit the execution monitoring information to the robot application controller 104.

The robot application controller 104 basically distributes the robot application on the basis of the information of the plurality of robots 120. The robot application controller 104 receives the information of the plurality of robots 120 from the robot information manager 103. At the same time, the robot application controller 104 receives the robot application combining the plurality of components for driving the plurality of robots 120 based on the user's request with each other from the robot application generator 102.

The robot application controller 104 analyzes the information of the plurality of components included in the robot application. The robot application controller 104 selects the plurality of nodes corresponding to the plurality of components by analyzing the information of the plurality of components. Thereafter, the robot application controller 104 matches the plurality of components with the plurality of nodes corresponding to the plurality of components, respectively. In matching, the plurality of components may be matched with the plurality of nodes. For example, one component may be double-matched with the plurality of nodes. Further, the plurality of components may be matched with one node. Similarly, the plurality of components may be double-matched with the plurality of nodes.

The robot application controller 104 distributes the robot application to the plurality of robots 120 on the basis of a matching result.

In distribution, the robot application itself may be distributed to each of the plurality of robots 120 without the matching. When the robot application itself is distributed, the robot application controller 104 transmits the robot application to the each of the plurality of robots 120 together with the plurality of components. In this case, the robot analyzes and determines the plurality of components to be allocated to the nodes.

In the embodiment of the present invention, each of the plurality of components to be distributed to the plurality of robots 120, in the robot application is selectively distributed on the basis of the matching result. That is, the plurality of components corresponding to the plurality of nodes included in the plurality of robots, respectively in the robot application are distributed on the basis of the information of the plurality of robots.

The robot application controller 104 may further include a function of generating and transferring a command to execute the plurality of components according to a predetermined execution sequence while distributing the robot application to the plurality of robots 120. The execution priority among the plurality of components included in the robot application may be determined.

For example, when a robot a 120a measures temperature and thereafter, a cooler may be operated based on temperature measured by a robot b 120b. In this case, a component for measuring temperature is executed in a temperature sensor node included in the robot a 120a and thereafter, a temperature controlling component of a cooler driving node included in the robot b 120b should be able to be executed.

The robot application controller 104 may further include a function of generating an execution control command and transferring the generated execution control command to the plurality of robots 120 on the basis of the execution monitoring information. Specifically, when an error occurs in executing any one of the plurality of components that are being executed in the plurality of nodes included in the plurality of robots 120, respectively, an execution control command relating to the execution of the robot application is generated and transferred to each of the plurality of robots 120.

Alternately, when it is determined that any one of the plurality of components that are being executed in the plurality of nodes included in the plurality of robots 120, respectively violates the execution sequence, the robot application controller 104 generates the execution control command relating to the execution of the robot application and transfers the execution control command to each of the plurality of robots 120.

The execution control command includes at least one of a command to stop the execution of the robot application itself and the execution sequence information of the plurality of components in the embodiment of the present invention. That is, the execution control command represents a command to stop the execution of all the plurality of components that are being executed in the plurality of robots 120, respectively. Since the execution error or the execution sequence error of any one component may cause the overall execution error of the robot application in the robot application constituted by the plurality of components, the execution control command stops the execution of the robot application itself. After stopping the execution, the user may correct the error by using an error correction program or give a command of restarting the robot application.

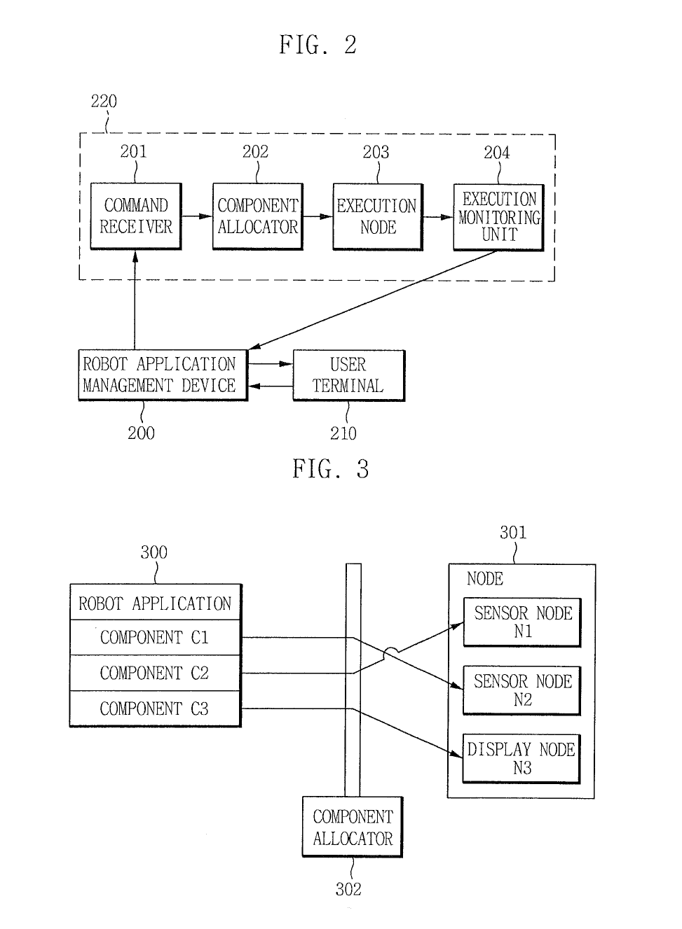

FIG. 2 is a block diagram of a robot driven by robot application according to an embodiment of the present invention. Hereinafter, duplicate parts with those of FIG. 1 will not be described.

Referring to FIG. 2, the robot driven by the robot application according to the embodiment of the present invention may include an execution node 203, a command receiver 201, a component allocator 202, and an execution monitoring unit 204. In the exemplary embodiment of the present invention, the execution node 203 will be the same as the node described in FIG. 1. Therefore, a plurality of execution nodes 203 may be provided.

That is, the execution node 203 included in the robot represents a basic unit of robot driving corresponding to a plurality of driving functions included in the robot.

The command receiver 291 receives at least one of the plurality of components included in the robot application and the execution control command of the robot application from a robot application management device. That is, the command receiver 201 serves as a data transceiver between the robot application management device and the robot.

In the embodiment of the present invention, the plurality of components may be all of the plurality of components included in the robot application. Alternately, the plurality of components may be the plurality of components that are matched with the plurality of nodes included in the robot.

In the embodiment of the present invention, the execution control command of the robot application includes at least one of whether or not to stop the execution of the robot application and the execution sequence information of the plurality of components. Whether or not to stop the execution of the robot application represents a command to stop the execution of the robot application itself in the robot application controller when the execution sequence or the execution of the robot application has the error as described above. Further, the robot application controller may also transfer the execution sequence of the components included in the plurality of components.

The component allocator 202 allocates the plurality of components received from the command receiver 201 to the plurality of execution nodes 203. When the component allocator 202 receives the plurality of components, the component allocator 202 analyzes the information of the plurality of components included in the plurality of components. In addition to the plurality of components, the component allocator 202 receives the execution control command of the robot application and allocates the execution control command to the execution node 203 that will receive the command.

The component allocator 202 analyzes which execution node 203 among the plurality of execution nodes 203 included in the robot the plurality of components will be allocated to as described above and thereafter, allocates the plurality of components to the execution nodes 203 corresponding to the plurality of components, respectively.

The plurality of components may be allocated to the plurality of execution nodes 203 in allocation. For example, one component may be double-allocated to the plurality of execution nodes 203. Further, the plurality of components may be allocated to one execution node 203. Similarly, the plurality of components may be double-allocated to the plurality of execution nodes 203.

The execution monitoring unit 204 monitors in real time whether or not the plurality of execution nodes 203 normally execute the plurality of components allocated to themselves in accordance with the execution control command.

The execution monitoring unit 204 thus receives the execution command for each of the plurality of components from the execution node 203 to compare the received execution control command with an execution state of the execution node 203.

While each of the plurality of components is executed in the execution node 203, the execution monitoring information is generated in real time. The execution monitoring information is transmitted to a robot application management device 200, that is, the robot application distributing and monitoring apparatus of FIG. 1 in real time. The robot application management device 200 transfers the execution state information of a robot application to the user terminal 210 on the basis of the execution monitoring information. Therefore, the user may verify the execution state of the robot application in real time through the user terminal 210.

When the execution control command for each of the plurality of components is compared with the execution state of the component of the execution node 203, the error may occur in the execution sequence or the execution of the component. In this case, the execution monitoring unit 204 transfers the execution monitoring information that the error occurs to the robot application management device 200. The robot application management device 200 transfers the execution control command to stop the execution of the robot application itself to the command receiver 201 in that case as described in FIG. 1.

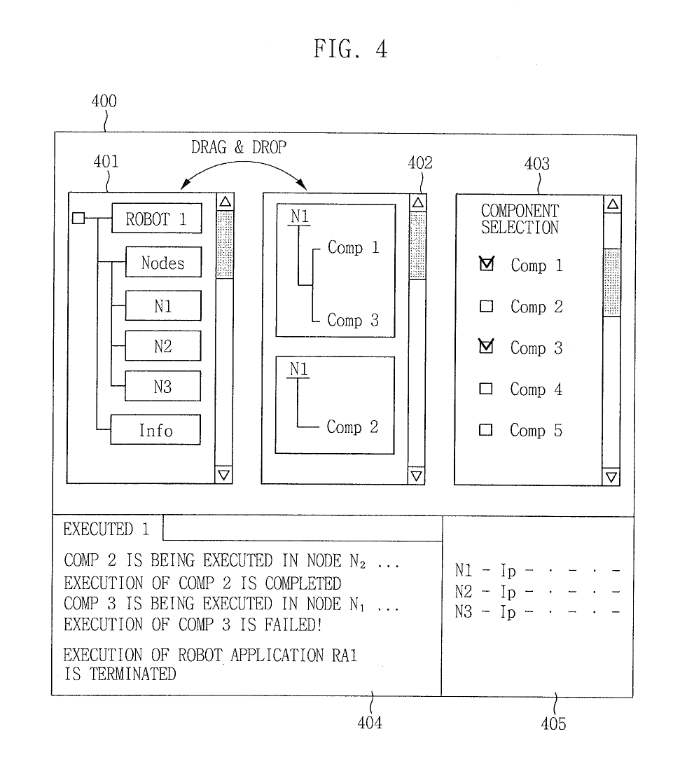

FIG. 3 illustrates a function of a component allocator. Hereinafter, duplicate parts with those of FIGS. 1 and 2 will not be described.

Referring to FIG. 3, robot application 300 including the plurality of components is transferred from the command receiver 201 to a component allocator 302. The component allocator 302 analyzes at least one of the plurality of components, the information of each of the plurality of components, and the execution control command corresponding to each of the plurality of components.

The information of each of the plurality of components may include at least one of the functions of the components, IP address of a plurality of nodes 301 corresponding to the components, and IP port numbers of the plurality of nodes 301 as described above.

The component allocator 302 allocates the plurality of components to the plurality of nodes 301 on the basis of the information of each of the plurality of components as described above. In addition, the component allocator 302 also allocates the execution control command corresponding to each of the plurality of components.

FIG. 4 illustrates an example of a screen of using an apparatus for distributing and monitoring robot application in a user terminal. Hereinafter, duplicate parts with those of FIGS. 1 to 3 will not be described.

Referring to FIG. 4, the user uses the robot application through the user terminal. A screen 400 shown in FIG. 4 is one example of a screen for the user to effectively use the robot application.

A robot information management menu 401 may be displayed on the screen 400. The user may verify the robot information through the robot information management menu 401 and may manage a robot to which the robot application will be distributed and the plurality of nodes included in the robot. As described in FIGS. 1 to 3, the user may select the plurality of robots and the plurality of nodes through the robot information management menu 401.

A component selection menu 403 may be included in the screen 400. When the selection of the component is completed, components Comp 1 and Comp 3 selected through the component selection menu 403 are not displayed on the screen 400 but immediately combined so as to generate the robot application. Alternately, a menu for displaying the information of the robot application and information on the included components Comp1 and Comp3 may additionally be provided on the screen 400.

When the user selects the component through the selection menu 403, the selected component is displayed in an allocation menu 402. The user may select a node to which each of the plurality of components will be allocated by a drag-and-drop method through the robot information management menu 401. The allocation menu 402 may include a function for allocating the plurality of components to the plurality of nodes.

When the plurality of components are allocated to the plurality of nodes through the allocation menu 402, information on the plurality of allocated nodes is automatically stored in the information on each of the of the plurality of components. Therefore, the robot application controller and the component allocator of the robot application management device allocate the plurality of components to the plurality of nodes, respectively.

Information on the plurality of nodes that are included in the plurality of robots and selected for executing the robot application is displayed on a node information window 405. In the node information menu 405 of FIG. 4, IP addresses of the nodes are set and displayed as representative information of the plurality of nodes.

The information on the execution state of the robot application transferred through the execution monitoring unit and the robot application controller is displayed in an execution state window 404. The user terminal may be connected with the robot application controller such that the execution state window 404 is displayed. The execution state of each of the plurality of components included in the robot application is displayed in the execution state window 404. Further, when the execution has the error, the execution state window 404 may display that the execution of the robot application stops.

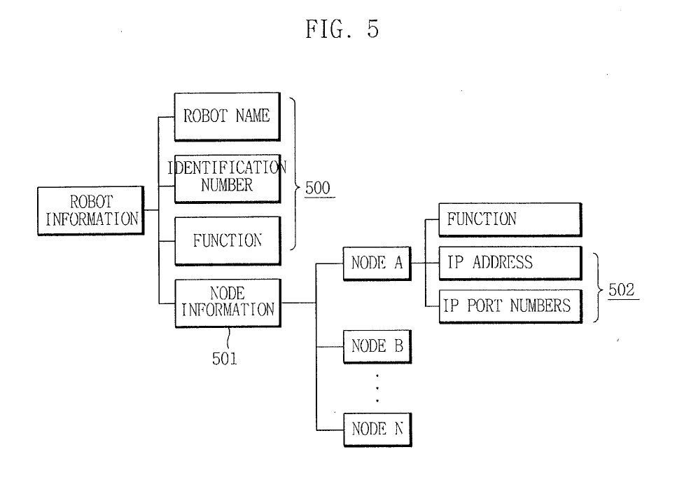

FIG. 5 illustrates a configuration example of information of robot of the present invention.

In addition to the information described in FIG. 1, a plurality of pieces of information on the robot may be included in the robot information. Further, the information of the plurality of robots may be included in the robot information, which will be managed by the robot information manager.

Referring to FIG. 5, the robot information may include robot identification information including a robot name, an identification number, and function of a robot 500, and node information 501. The robot name and the identification number may be included in the robot identification information.

The node information 501 includes information on the plurality of nodes included in the robot. Therefore, at least one of the function, the IP address, and the IP port number of each of the plurality of nodes may be included in the node information 501. The IP address and the IP port numbers 502 of each of the nodes may be used as identification information of each of the nodes and may be used for identification and communication at the time of allocating the plurality of components.

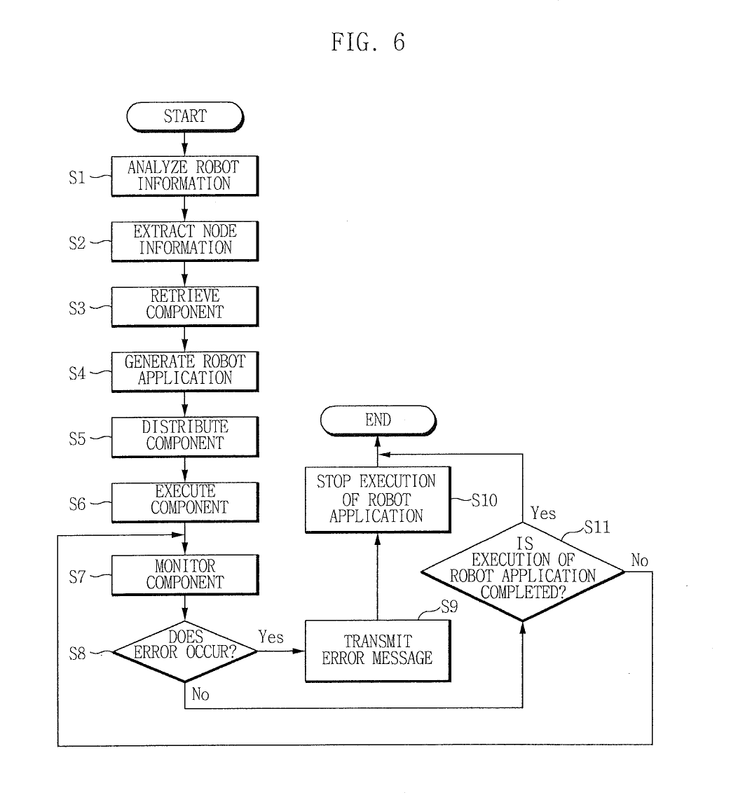

FIG. 6 is a flowchart of a method for distributing and monitoring robot application according to an embodiment of the present invention. Hereinafter, duplicate parts with those of FIGS. 1 to 5 will not be described.

Referring to FIG. 6, the robot application distributing and monitoring method according to the exemplary embodiment of the present invention first includes allowing a robot information manager to manage information of a plurality of robots constituted by a plurality of nodes classified in accordance with a function. The managing of the information of the robots includes allowing the robot information manager to analyze information of the plurality of robots required to execute the robot application (S1) and extracting information of the plurality of nodes included in the plurality of robots required to execute the robot application (S2).

Thereafter, a robot application generator generates robot application combining a plurality of components with each other.

The generating of the robot application includes allowing the robot application generator to retrieve and receive the plurality of components from an external server (S3) and to generate the robot application by combining the plurality of retrieved components with each other (S4).

When the robot application is generated, a robot application controller distributes the robot application, that is, the plurality of components to the plurality of robots on the basis of the information of the plurality of robots (S5). Step S5 may include distributing the plurality of components corresponding to the plurality of nodes included in the plurality of robots, respectively in the robot application on the basis of the information of the plurality of robots.

Further, step S5 may further include allowing the robot application controller to generate and distribute an execution control command including a command to execute the plurality of components in accordance with a predetermined execution sequence in addition to the plurality of components.

After step S5, the robot command receiver receives at least one of the robot applications, that is, the plurality of components included in the robot application and the execution control command of the robot application, and an execution node executes the plurality of components allocated by a component distributor (S6).

An execution monitoring unit monitors the execution of the component when step S6 is executed (S7). While the execution monitoring unit monitors the execution of the plurality of components in the plurality of nodes in real time at step S7, it is determined whether or not the execution of the plurality of components has an error (S8). If the error occurs, an error message is transmitted (S9). In this case, when the error message is included in execution monitoring information received in real time, the robot application controller generates a command to stop the execution of the robot application and transmits the generated command to the command receiver of the robot (S10). If no error occurs, the execution of the robot application is continuously monitored. In addition, it is determined whether or to the execution of the robot application is completed (S11).

While the present invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims. Accordingly, the actual technical protection scope of the present invention must be determined by the spirit of the appended claims.

What is claimed is:

1. An apparatus for distributing and monitoring robot application, comprising:
a robot information manager managing information of a plurality of robots constituted by a plurality of nodes classified by a driving function;
a robot application generator generating the robot application by combining a plurality of components for driving the plurality of robots; and
a robot application controller distributing the robot application to the plurality of robots on the basis of the information of the plurality of robots and receiving execution monitoring information of the robot application.

2. The apparatus of claim 1, wherein the robot application controller further has a function of generating a command to execute each of the plurality of components in accordance with a predetermined execution sequence.

3. The apparatus of claim 2, wherein the robot application controller further has a function of generating a command to stop the execution of the robot application when it is determined that any one of the plurality of components violates the predetermined execution sequence.

4. The apparatus of claim 1, wherein the information of the plurality of robots includes one or more of identification information of the robots, functional information of the robots, functional information of the plurality of nodes, and IP address information and IP port numbers information of the plurality of nodes.

5. The apparatus of claim 1, wherein the robot application generator further has a function of retrieving and receiving the plurality of components from an external server.

6. The apparatus of claim 1, wherein the robot application controller distributes the plurality of components which are included in the robot application and corresponding to each of the plurality of nodes included in the plurality of robots, on the basis of the information of the plurality of robots.

7. The apparatus of claim 1, wherein the robot application controller further has a function of generating the command to stop the execution of the robot application when an error occurs in the execution of any one of the plurality of components included in the robot application on the basis of the execution monitoring information.

8. A robot driven by robot application, comprising:
a command receiver receiving one or more of a plurality of components included in the robot application and an execution control command from a robot application management device;
a component allocator allocating one or more of the plurality of components and the execution control command to a plurality of execution nodes based on information of the robot; and
an execution monitoring unit monitoring whether or not the components corresponding to the plurality of execution nodes are normally executed.

9. The robot of claim 8, wherein the execution control command includes one or more of information whether or not to stop the execution of the robot application and information of execution sequence of the plurality of components.

10. The robot of claim 8, wherein the plurality of execution nodes correspond to each of a plurality of driving functions included in the robot.

11. The robot of claim 8, wherein the information of the robot includes one or more of identification information of the robot, functional information of the robot, functional information of the plurality of nodes, and IP address information and IP port numbers information of the plurality of nodes.

12. A method for distributing and monitoring robot application, comprising:
managing information of a plurality of robots constituted by a plurality of nodes classified by a driving function by a robot information manager;
generating the robot application by combining a plurality of components for driving the plurality of robots by a robot application generator;
distributing the robot application to the plurality of robots on the basis of the information of the plurality of robots by a robot application controller; and
receiving execution monitoring information of the robot application by the robot application controller.

13. The method of claim 12, further comprising retrieving and receiving the plurality of components from an external server by the robot application controller.

14. The method of claim 12, wherein the information of the plurality of robots includes one or more of identification information of the robots, functional information of the robots, functional information of the plurality of nodes, and IP address information and IP port numbers information of the plurality of nodes.

15. The method of claim 12, wherein the distributing distributes the plurality of components which are included in the robot application and corresponding to each of the plurality of nodes included in the plurality of robots, on the basis of the information of the plurality of robots.

16. The method of claim 12, further comprising generating a command to execute the plurality of components in accordance with a predetermined execution sequence by the robot application controller.

17. The method of claim 12, further comprising allowing receiving one or more of a plurality of components included in the robot application and an execution control command of the robot application by a command receiver of the robot.

18. The method of claim 12, further comprising allocating one or more of the plurality of components and the execution control command to a plurality of execution nodes based on information of the robot by a component allocator of the robot.

19. The method of claim 12, further monitoring whether or not the components corresponding to the plurality of execution nodes are normally executed by an execution monitoring unit of the robot.

20. The method of claim 12, further comprising generating the command to stop the execution of the robot application when an error occurs in the execution of any one of the plurality of components or one or more of the execution sequences based on the execution monitoring information by the robot application controller.
